(19) United States
(12) Patent Application Publication
(10) Pub. No.: US 2013/0330517 A1
(43) Pub. Date: Dec. 12, 2013

(54) Thermoforming Cover of Portable Electronic Apparatus

(71) Applicant: Shan-Tien Hwang, Taipei City (TW)

(72) Inventor: Shan-Tien Hwang, Taipei City (TW)

(73) Assignee: TOPBOUND TECHNOLOGY INC., New Taipei City (TW)

(21) Appl. No.: 13/494,018

(22) Filed: Jun. 12, 2012

(51) Int. Cl. B32B 3/28; B29C 45/14; B32B 3/30; B32B 27/36; B32B 27/08; B32B 27/40; B44C 3/02; B44C 3/08

(52) U.S. Cl. 428/161; 156/196; 264/255; 156/219; 428/412; 428/423.1; 428/480; 428/414; 428/448; 428/423.3; 428/423.7; 428/339; 428/334; 428/174

(57) ABSTRACT

This disclosure concerns a thermoforming cover of portable electronic apparatus, comprising: a first transparent layer, being made by plastic material; a color layer, being printed on the first transparent layer; an adhesive layer, being covered on the color layer; and a second transparent layer, being made by plastic material, and disposed on the adhesive layer; wherein the first transparent layer can be set as substrate, and the color layer, the adhesive layer and the second transparent layer are disposed on the first transparent layer by step, then a thermoforming cover can be manufactured in a mold through thermoforming process.

### BACKGROUND OF THE INVENTION

1. Technical Field

The present invention relates to a thermoforming cover of portable electronic apparatus, and more particularly, to a cover with thin and slim shape being capable of covering portable electronic apparatus and reducing the effect of scratch.

2. Description of Related Art

From industry point of view, plastic materials are light, easy fabrication and inexpensive, also have been widely used in process of injection molding or thermoforming, for example, plastic chair, housing of mouse or case of general electronic device. With process of molding, melting plastic is fed into mold cavity with specific shape, and the plastic can form shield cover according to the specific shape of mold cavity by variation of pressure and temperature.

The shield cover can be painted on surface according to designed drawing by the way of spray process for decorating and illustrating the appearance of the shield cover, then the shield cover can be more pleased in visual presentation. However, the paint sprayed on the shield cover has low wear resistance, and the shield cover is easily suffered scratches everywhere by abrasion over time. To improve this issue, protecting coating material is disposed on the shield cover in the conventional method, wherein the protecting coating material is transparent.

The foregoing depiction is clearly introduced with conventional shield cover and the manufacture method related to spray and coating, it is known the conventional shield cover still has shortcomings:

(1) cost a lot of solvent used in spray process: in the conventional method, the paint on shield cover is formed by the way of spray process. Since the way of spray process needs a lot of solvent to spray the paint on the shield cover, the cost of the solvent is easily out of control or over waste, and the environment pollution is also concerned.
(2) the limitation of thickness of shield cover can not be lower then 0.4 mm: in general injection molding, plastic material is forced through nozzle that rests against the mold and filled in the mold cavity. The mold cavity must be designed with more space for filling the plastic material uniformly, or the injection molding can not be success. Due to the space designed, the limitation of the thickness of the shield cover can not be lower then 0.4 mm, thus, the thickness of the shield cover is about 0.8 mm in general market. It is not only wastes the cost of the plastic material, but also limits the space design, moreover, production yield of shield cover is concerned.
(3) spray process costs a lot of time: in the conventional spray process, pattern is formed on the shield cover first, then the paint can be sprayed on the shield cover. The paint on the shield cover needs multi-layer to present color with good quality, or the drawing can not be shown very well. Thus, the spray process needs multi-steps and costs a lot of time.

Accordingly, in view of the conventional shield cover still has shortcomings and drawbacks, the inventor of the present application has made great efforts to make inventive research thereon and eventually provided a thermoforming cover of portable electronic apparatus.

### SUMMARY OF THE INVENTION

The primary objective of the present invention is to provide a thermoforming cover of portable electronic apparatus, in which, the paint is printed on the first transparent layer or the adhesive layer by printing technology, so that, the present invention can save the solvent on printing technology by 80% then than spray process.

The another objective of the present invention is to provide a thermoforming cover of portable electronic apparatus, in which, the color layer can be protected, and the thickness requested in the present invention can be also reduced about 50% then than conventional shield cover, thus, the amount of the production material including plastic and Epoxy in the present invention can be saved and controlled.

The another objective of the present invention is to provide a thermoforming cover of portable electronic apparatus, in which, the printing technology is used in the present invention to print the color layer, and the process time can be reduced.

The primary objective of the present invention is to provide a thermoforming cover of portable electronic apparatus, being manufactured through thermoforming process, comprising: a first transparent layer, being made by plastic material; a color layer, being printed on the first transparent layer; an adhesive layer, being covered on the color layer; and a second transparent layer, being made by plastic material, and disposed on the adhesive layer; wherein the first transparent layer can be set as substrate, and the color layer, the adhesive layer and the second transparent layer are disposed on the first transparent layer by step, then a thermoforming cover can be manufactured in a mold through thermoforming process. Moreover, The first transparent layer and the second transparent layer are selected from Polycarbonate (PC), Polyethylene terephthalate (PET) or Thermoplastic Polyurethane (TPU); the adhesive layer is selected from silicon, Epoxy or Polyurethane (PU); and the color layer is polyurethane ink. Beside, the first transparent layer and the second transparent layer have a thickness of 0.05-0.3 mm; and the color layer and the adhesive layer have a thickness of 0.01-0.1 mm

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a schematic of first embodiment of thermoforming cover layers according to the present invention;

FIG. 2 is method for manufacturing thermoforming cover of portable electronic apparatus according to the present invention;

FIGS. 3A and 3B are steps of manufacture method in accordance with the method of FIG. 2;

FIG. 4 is the thermoforming cover in accordance with the cover of FIG. 3B;

FIGS. 5A and 5B are steps of injection molding process;

FIG. 6A is the thermoforming cover without injection molding process in stereo view;

FIG. 6B is the thermoforming cover without injection molding process in side view;

FIG. 6C is the thermoforming cover without injection molding process in top view;

FIG. 6D is the thermoforming cover after injection molding process in stereo view; and

FIG. 7 is a schematic of second embodiment of thermoforming cover layers according to the present invention.

### DETAILED DESCRIPTION OF THE INVENTION

To more clearly describe a thermoforming cover of portable electronic apparatus according to the present invention, an embodiment of the present invention will be described in detail with reference to the attached drawings hereinafter.

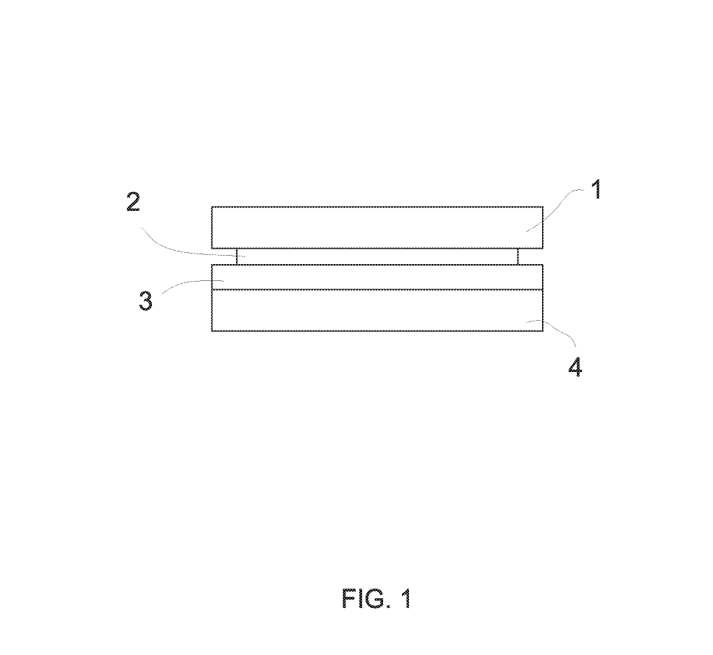

Please refer to FIG. 1, which illustrate a schematic of first embodiment of thermoforming cover layers according to the present invention. A thermoforming cover of portable electronic apparatus is manufactured through thermoforming process, and comprises a first transparent layer 4 being made by plastic material; a color layer 3 being printed on the first transparent layer 4; an adhesive layer 2 being covered on the color layer 3; and a second transparent layer 1 being made by plastic material, and disposed on the adhesive layer 2; wherein the first transparent layer 4 can be set as substrate, and the color layer 3, the adhesive layer 2 and the second transparent layer 1 are disposed on the first transparent layer 4 by step, then a thermoforming cover can be manufactured in a mold through thermoforming process. The first transparent layer 4 and the second transparent layer 1 are selected from Polycarbonate (PC), Polyethylene terephthalate (PET) or Thermoplastic Polyurethane (TPU); the adhesive layer 2 is selected from silicon, Epoxy or Polyurethane (PU); and the color layer 3 is polyurethane ink. Moreover, in the present invention, the first transparent layer 4 has a thickness of 0.05-0.3 mm; the color layer 3 has a thickness of 0.01-0.1 mm; the adhesive layer 2 has a thickness of 0.01-0.1 mm; and the second transparent layer 1 has a thickness of 0.05-0.3 mm.

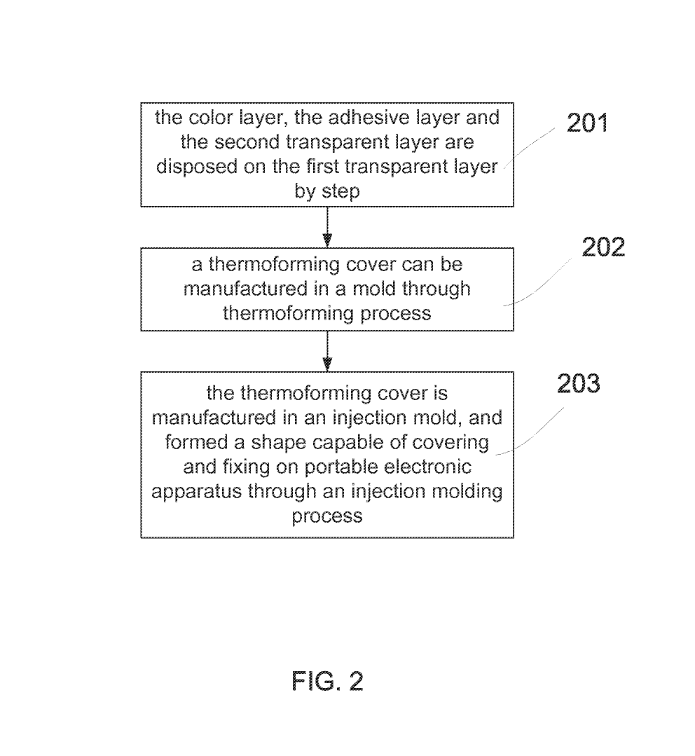

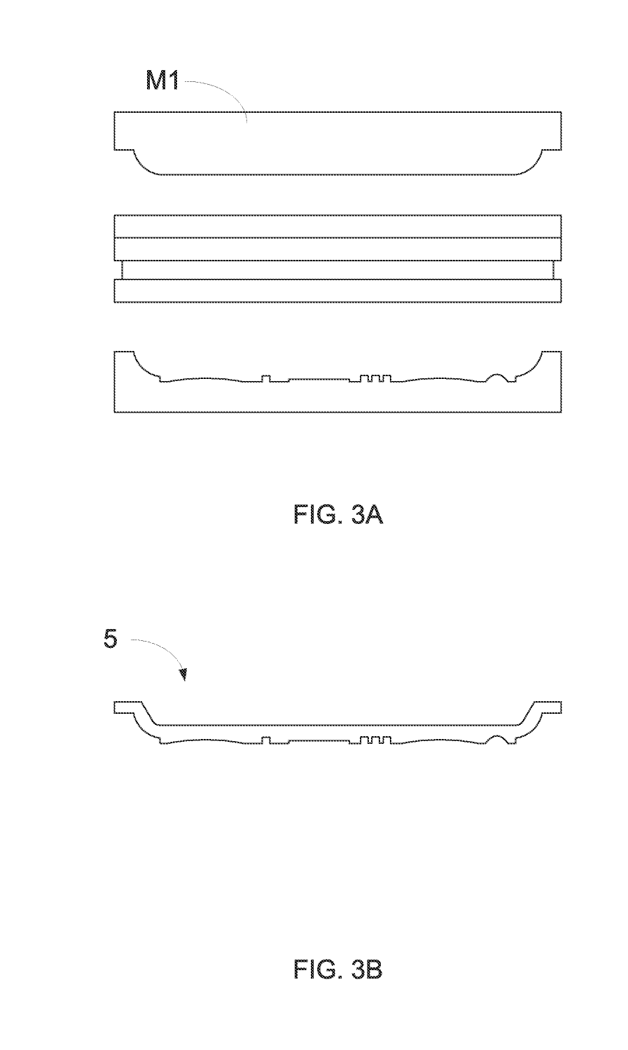

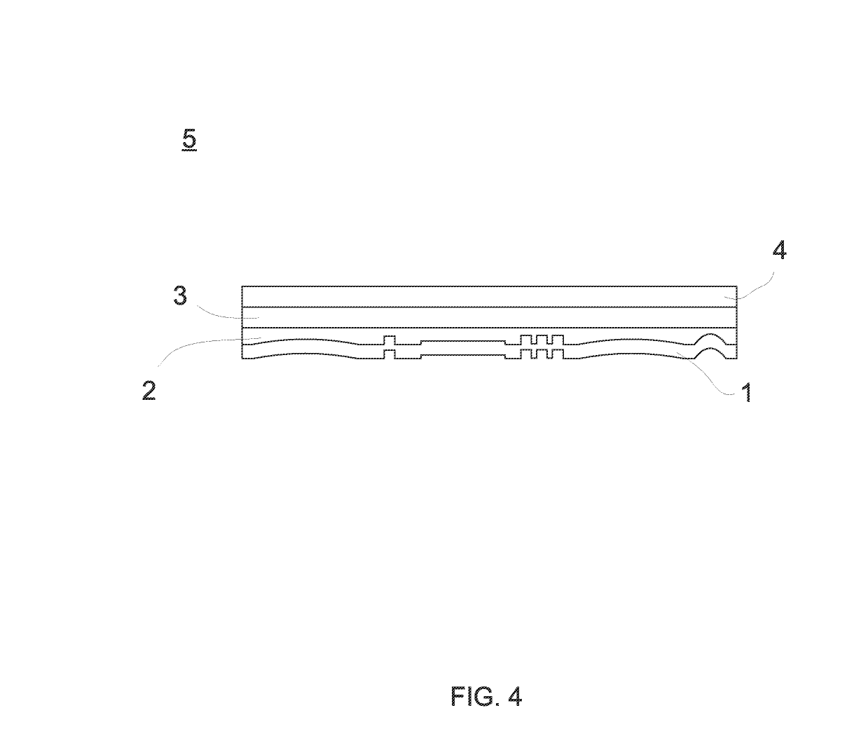

Please refer to FIG. 2, which illustrates method for manufacturing thermoforming cover of portable electronic apparatus according to the present invention, thermoforming cover of portable electronic apparatus according to the present invention can be manufactured by method comprising: (201) the color layer, the adhesive layer and the second transparent layer are disposed on the first transparent layer by step; and (202) a thermoforming cover can be manufactured in a mold through thermoforming process. The mold in step (202) can be used in thermoforming process and modified according to custom request for presenting pattern on the thermoforming cover, thus, the second transparent layer 1 is able to form pattern through thermoforming process in the mold. Please refer to FIG. 3A and FIG. 3B, which illustrate steps of manufacture method in accordance with the method of FIG. 2, wherein the color layer, the adhesive layer and the second transparent layer are disposed on the first transparent layer by step, and four layers are placed into a thermoforming mold M1, then a thermoforming cover 5 with pattern can be manufactured through thermoforming process. Please refer to FIG. 4, which illustrates the thermoforming cover in accordance with the cover of FIG. 3B, wherein the adhesive layer 2 is Epoxy, and the second transparent layer 1 presents pattern after thermoforming process.

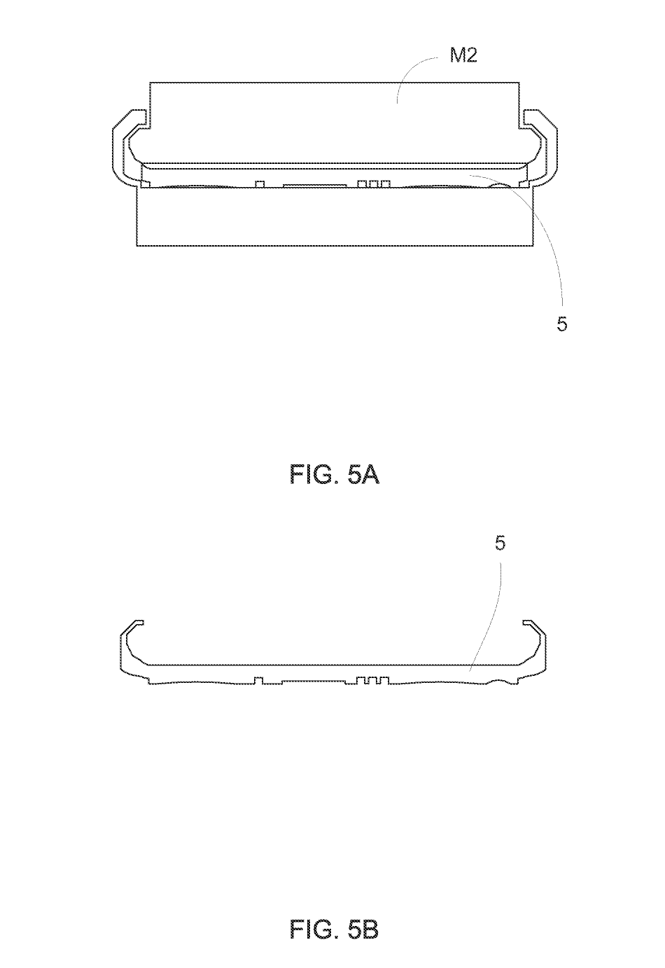

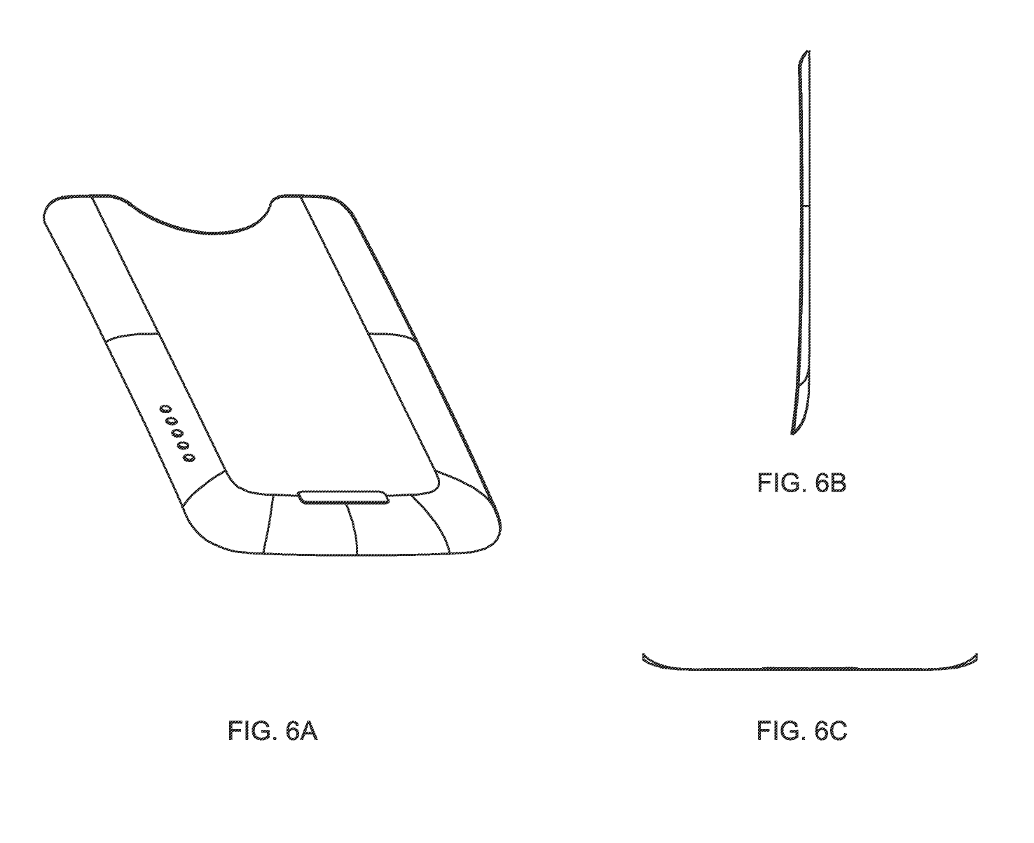

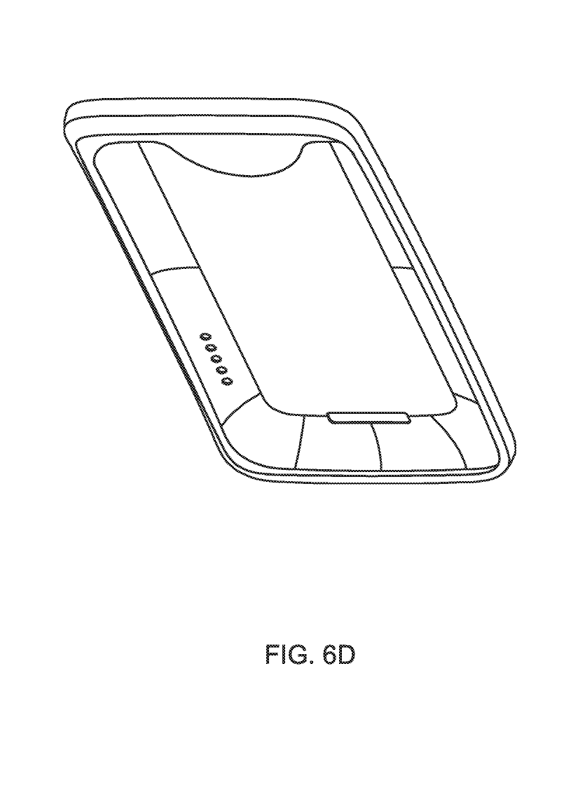

Please refer to FIG. 5A and FIG. 5B, which illustrate steps of injection molding process, and refer to FIG. 2 simultaneously. The present invention further includes (203) the thermoforming cover is manufactured in an injection mold, and formed a shape capable of covering and wrapping portable electronic apparatus through an injection molding process. As shown in FIG. 5A, the thermoforming cover 5 is placed into an injection mold M2 and formed a specific shape after injection molding process as shown in FIG. 5B. Please refer to FIG. 6A-6D, wherein FIG. 6A-6C illustrate the thermoforming cover without injection molding process in stereo view, side view and top view, respectively. FIG. 6D illustrates the thermoforming cover after injection molding process in stereo view. The thermoforming cover 5 is capable of covering and wrapping portable electronic apparatus after injection molding process.

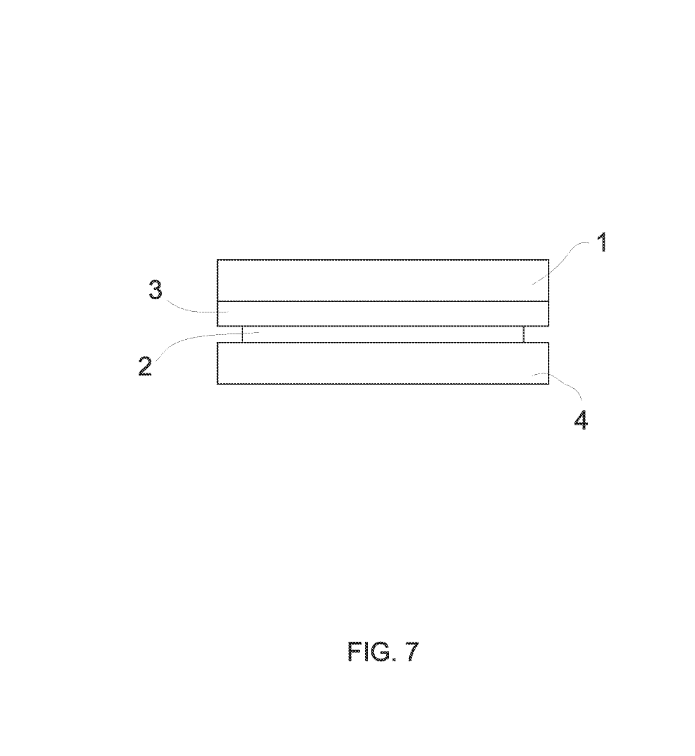

Furthermore, the present invention also provides another embodiment, please refer to FIG. 7, which illustrates a schematic of second embodiment of thermoforming cover layers according to the present invention. The second embodiment of thermoforming cover of the present invention can be manufactured through thermoforming process, and comprises a first transparent layer 4 being made by plastic material; an adhesive layer 2 being covered on the first transparent layer 4; a color layer 3 being printed on the adhesive layer 2; and a second transparent layer 1 being made by plastic material, and disposed on the color layer 3; wherein the first transparent layer 4 can be set as substrate, and the adhesive layer 2, the color layer 3 and the second transparent layer 1 are disposed on the first transparent layer 4 by step, then a thermoforming cover can be manufactured in a mold through thermoforming process. Each layer in second embodiment of the present invention has the same thickness as the thickness in first embodiment of the present invention.

In first embodiment, the color layer 3 of the present invention is printed on the first transparent layer 4. In second embodiment, the color layer 3 of the present invention is printed on the adhesive layer 2. The printing technology in present invention can be laser printing, screen printing and thermal printing.

Thus, the thermoforming cover according to the present invention has been disclosed above completely and clearly. In summary, the thermoforming cover of portable electronic apparatus according to the present invention has following advantages:

(1) in the present invention, the color layer is printed on the first transparent layer or the adhesive layer, and covered by the second transparent layer. Due to the printing technology only request few solvent, so the amount of the solvent can be saved and controlled. Moreover, the printing technology has as good quality as spray process, and the color layer can be protected by the second transparent layer.
(2) the color layer is protected by the second transparent layer, and the thickness of shield cover in the present invention can be controlled around 0.4 mm. That means the present invention can provide the same function as the conventional shield, and less thickness. So that, it is clearly known the present reduces production material and increases production yield.

(3) the printing technology requests less process time than spray process. The printing technology is used in the present invention to print the color layer, thus, the process time can be reduced.

The above description is made on embodiments of the present invention. However, the embodiments are not intended to limit scope of the present invention, and all equivalent implementations or alterations within the spirit of the present invention still fall within the scope of the present invention.

I claim:

1. A thermoforming cover of portable electronic apparatus, being manufactured through thermoforming process, comprising:
a first transparent layer, being made by plastic material;
a color layer, being printed on the first transparent layer;
an adhesive layer, being covered on the color layer; and
a second transparent layer, being made by plastic material, and disposed on the adhesive layer;
wherein the first transparent layer can be set as substrate, and the color layer, the adhesive layer and the second transparent layer are disposed on the first transparent layer by step, then a thermoforming cover can be manufactured in a mold through thermoforming process.

2. The thermoforming cover of portable electronic apparatus of claim 1, wherein the first transparent layer and the second transparent layer are selected from the group consisting of: Polycarbonate (PC), Polyethylene terephthalate (PET) and Thermoplastic Polyurethane (TPU).

3. The thermoforming cover of portable electronic apparatus of claim 1, wherein the adhesive layer is selected from the group consisting of: silicon, Epoxy and Polyurethane (PU).

4. The thermoforming cover of portable electronic apparatus of claim 1, wherein the color layer is polyurethane ink.

5. The thermoforming cover of portable electronic apparatus of claim 1, wherein the first transparent layer has a thickness of 0.05-0.3 mm.

6. The thermoforming cover of portable electronic apparatus of claim 1, wherein the color layer has a thickness of 0.01-0.1 mm.

7. The thermoforming cover of portable electronic apparatus of claim 1, wherein the adhesive layer has a thickness of 0.01-0.1 mm.

8. The thermoforming cover of portable electronic apparatus of claim 1, wherein the second transparent layer has a thickness of 0.05-0.3 mm.

9. The thermoforming cover of portable electronic apparatus of claim 1, being manufactured by method comprising:
(1) the color layer, the adhesive layer and the second transparent layer are disposed on the first transparent layer by step; and
(2) a thermoforming cover can be manufactured in a mold through thermoforming process.

10. The thermoforming cover of portable electronic apparatus of claim 9, wherein in the step (2), the first transparent layer and the second transparent layer are able to form pattern through thermoforming process.

11. The thermoforming cover of portable electronic apparatus of claim 9, wherein the method can further comprise: (3) the thermoforming cover is manufactured in an injection mold, and formed a shape capable of covering and wrapping portable electronic apparatus through an injection molding process.
